(19) United States
(12) Patent Application Publication
(10) Pub. No.: US 2018/0313663 A1
(43) Pub. Date: Nov. 1, 2018

(54) MOBILE TERMINAL AND VEHICLE

(71) Applicant: KYOCERA CORPORATION, Kyoto (JP)

(72) Inventor: Hiroki KOBAYASHI, Osaka (JP)

(21) Appl. No.: 16/012,484

(22) Filed: Jun. 19, 2018

Related U.S. Application Data
(63) Continuation of application No. PCT/JP2016/086742, filed on Dec. 9, 2016.

(30) Foreign Application Priority Data
Dec. 21, 2015 (JP) 2015-248489

(51) Int. Cl. G01C 21/36; H04W 4/02; B60W 50/00; B60W 50/14; G08B 21/18

(52) U.S. Cl. CPC G01C 21/3697; H04W 4/027; G08B 21/182; B60W 50/14; B60W 50/0098

(57) ABSTRACT

At least one processor is configured to cause a display to display a message indicating a risk of motion sickness when a velocity of a mobile terminal satisfies a predetermined criterion.

### CROSS-REFERENCE TO RELATED APPLICATION

The present application is a continuation based on PCT Application No. PCT/JP2016/086742 filed on Dec. 9, 2016, which claims the benefit of Japanese Application No. 2015-248489, filed on Dec. 21, 2015. Both of PCT Application No. PCT/JP2016/086742 and Japanese Application No. 2015-248489 are entitled “Mobile Terminal and Vehicle.” The content of which is incorporated by reference herein in their entirety.

### FIELD

Embodiments of the present disclosure relate to a mobile terminal and a vehicle.

### BACKGROUND

Often times, a passenger succumbs to motion sickness more easily than a driver in the vehicle. This is because the driver, who is constantly looking forward, visually ascertains curves or bumps in advance, and as such, can deal with these cues by unconsciously adjusting the body. The passenger, on the other hand, cannot make prior adjustments as described above, and is accordingly more susceptible to motion sickness in many cases.

Devices for preventing motion sickness have conventionally been known. For example, one conventional navigation device accepts registration for a passenger who succumbs to motion sickness and, when determining that an occupant who succumbs to motion sickness is onboard, provides motion sickness information.

### SUMMARY

A mobile terminal according to one embodiment of the present disclosure includes a display and at least one processor configured to cause the display to display a message indicating a risk of motion sickness when the velocity of the mobile terminal satisfies a predetermined criterion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an illustration of a configuration of a mobile terminal.

FIG. 2 is an illustration of a flowchart showing an example of an operation procedure of the mobile terminal.

FIGS. 3A, 3B, and 3C are illustrations of examples of screens displayed on the mobile terminal.

FIG. 4 is an illustration of a flowchart showing another example of the operation procedure of the mobile terminal.

FIG. 5 is an illustration of a flowchart showing another example of the operation procedure of the mobile terminal.

FIGS. 6A and 6B show other examples of the screens displayed on the mobile terminal.

FIG. 7 is an illustration of a flowchart showing another example of the operation procedure of the mobile terminal.

FIG. 8 is another illustration of the configuration of the mobile terminal.

FIG. 9 is an illustration of a flowchart showing another example of the operation procedure of the mobile terminal.

FIGS. 10A and 10B are illustrations of other examples of the screens displayed on the mobile terminal.

FIG. 11 is an illustration of a flowchart showing another example of the operation procedure of the mobile terminal.

FIG. 12 is an illustration of the configuration of a vehicle.

FIG. 13 is an illustration of a flowchart showing another example of the operation procedure of the mobile terminal.

FIG. 14 is an illustration of a flowchart showing another example of the operation procedure of the mobile terminal.

FIG. 15 is an illustration of a flowchart showing another example of the operation procedure of the mobile terminal.

FIG. 16 is another illustration of the configuration of the mobile terminal

FIG. 17 is another illustration of a configuration of a vehicle.

### DETAILED DESCRIPTION

Embodiments will be described below with reference to the drawings.

### First Embodiment

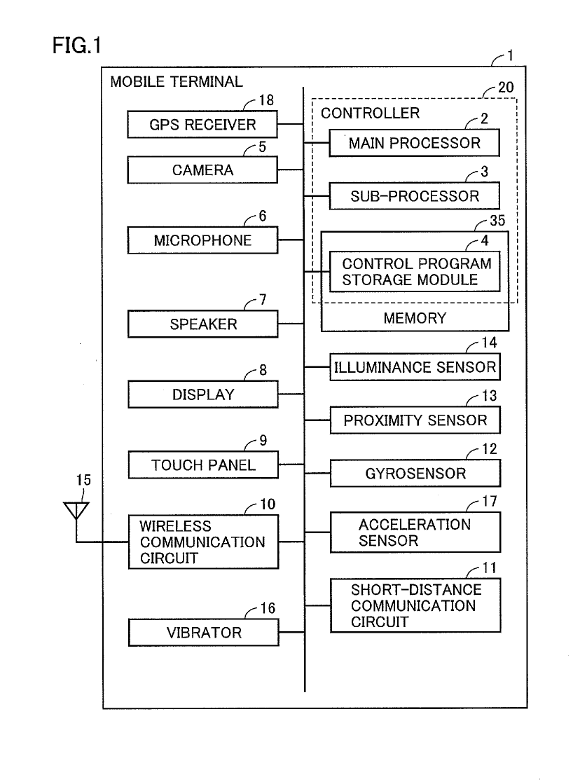

FIG. 1 is an illustration of a configuration of a mobile terminal 1 according to a first embodiment.

With reference to FIG. 1, mobile terminal 1 includes a main processor 2, a sub-processor 3, a memory 35, a camera 5, a microphone 6, a speaker 7, a display 8, a touch panel 9, a wireless communication circuit 10, a short-distance communication circuit 11, a gyrosensor 12, an acceleration sensor 17, a proximity sensor 13, an illuminance sensor 14, an antenna 15, a vibrator 16, and a GPS receiver 18.

Main processor 2 can manage overall control of components of mobile terminal 1. For reduced power consumption, main processor 2 enters a sleep mode when certain conditions are satisfied. Main processor 2 does not operate during the sleep mode.

Sub-processor 3 can mainly receive signals from illuminance sensor 14, proximity sensor 13, gyrosensor 12, and acceleration sensor 17 and notify main processor 2 of the detection results of these sensors. Main processor 2 can enter a normal mode when receiving the detection results of these sensors from sub-processor 3 during the sleep mode.

Memory 35 can store various types of data and programs. Memory 35 includes a control program storage module 4 that stores a control program.

According to various embodiments, at least one processor of main processor 2, sub-processor 3, and another processor (not shown) may be implemented as a single integrated circuit (IC) or as multiple communicably connected integrated circuit ICs and/or discrete circuits. It is appreciated that at least one processor can be implemented in accordance with various known technologies. In one embodiment, at least one processor includes one or more circuits or units configured to, for example, execute an instruction stored in a relevant memory to execute one or more data computing procedures or processes. In other embodiments, at least one processor may be implemented as firmware (e.g., discrete logic components) configured to perform one or more data computing procedures or processes. According to various embodiments, at least one processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

For example, main processor 2 and sub-processor 3 may function as controller 20 by executing a control program.

Controller 20 can manage overall control of mobile terminal 1.

Speaker 7 can output the voice of a call partner, a ring tone, an alarm sound, or the like.

Microphone 6 can receive the sound from the outside of mobile terminal 1, such as the voice of the user of mobile terminal 1.

Camera 5 can pick up an image of a subject.

According to various embodiments, display 8 may be implemented by, for example, a liquid crystal display, an organic electro luminescence (EL) display, an inorganic EL display, or by any display techniques or devices known in any combination of the above displays.

Touch panel 9 can accept an input from the user. Touch panel 9 is of, for example, capacitance type. Touch panel 9 is provided on a surface of display 8.

Wireless communication circuit 10 can communicate with, for example, a wireless base station through antenna 15.

Short-distance communication circuit 11 can establish short-distance wireless communication with another device such as a wearable device in accordance with a Bluetooth® system. Short-distance communication circuit 11 can establish short-distance wireless communication with a vehicle when mobile terminal 1 is brought into the vehicle. The Bluetooth® system is one example of the short-distance wireless communication systems, and short-distance communication circuit 11 can follow another short-distance wireless communications system. Non-limiting examples of the other short-distance wireless communication systems include a digital enhanced cordless telecommunications (DECT) system, a dedicated short range distance communications (DSRC) system, an IBeacon system, an IrDA system, a near field communication (NFC) system, a TransferJet system, a WiMedia Alliance system, a ZigBee system, a Z-wave system, and a Wi-Fi system.

Gyrosensor 12 can detect the angular velocity of mobile terminal 1. Mobile terminal 1 can integrate an angular velocity output from gyrosensor 12 to detect its direction (tilt).

Acceleration sensor 17 can detect an acceleration, that is, can detect by which amount and in which direction the velocity of mobile terminal 1 has changed for a certain period of time. Mobile terminal 1 may obtain accelerations detected by acceleration sensor 17 at predetermined time intervals over time and analyze the periodic characteristics of the obtained accelerations. Acceleration sensor 17 includes, for example, a triaxial acceleration sensor. In order to detect periodic characteristics of the accelerations, mobile terminal 1 may subject the acceleration of each axis or a predetermined axis to Fast Fourier Transform (FFT) to obtain a power spectrum, thereby analyzing the periodic characteristics.

Proximity sensor 13 emits infrared rays and converts reflected light into a current Mobile terminal 1 can use proximity sensor 13 to detect whether any object is present in its proximity.

Illuminance sensor 14 converts the light that enters mobile terminal 1 into a current. Mobile terminal 1 can use illuminance sensor 14 to detect the illuminance of its installation place.

Vibrator 16 can vibrate when a user needs to be notified, for example, when an incoming call is received.

GPS receiver 18 can detect a current position. Mobile terminal 1 can regard its position as the vehicle's position, its velocity as the vehicle's velocity, and its acceleration as the vehicle's acceleration when mobile terminal 1 is brought into the vehicle. GPS receiver 18 is one example of the positional information receiver. The positional information receiver may be a receiver capable of receiving navigation signals transmitted from navigation satellites. Non-limiting examples of the positional information receiver include a GLObal'naya NAvigatsionnaya Sputnikovaya Sistema (GLONASS) receiver, a Galileo receiver, a Compass receiver, an Indian regional navigational satellite system (IRNSS) receiver, and a quasi-zenith satellite system (QZSS) receiver. Mobile terminal 1 may include multiple positional information receivers and specify its position based on the navigation signal obtained by each of the multiple positional information receivers.

Description will be given with regard to a method of making a user less susceptible to motion thickness when mobile terminal 1 is brought into a vehicle.

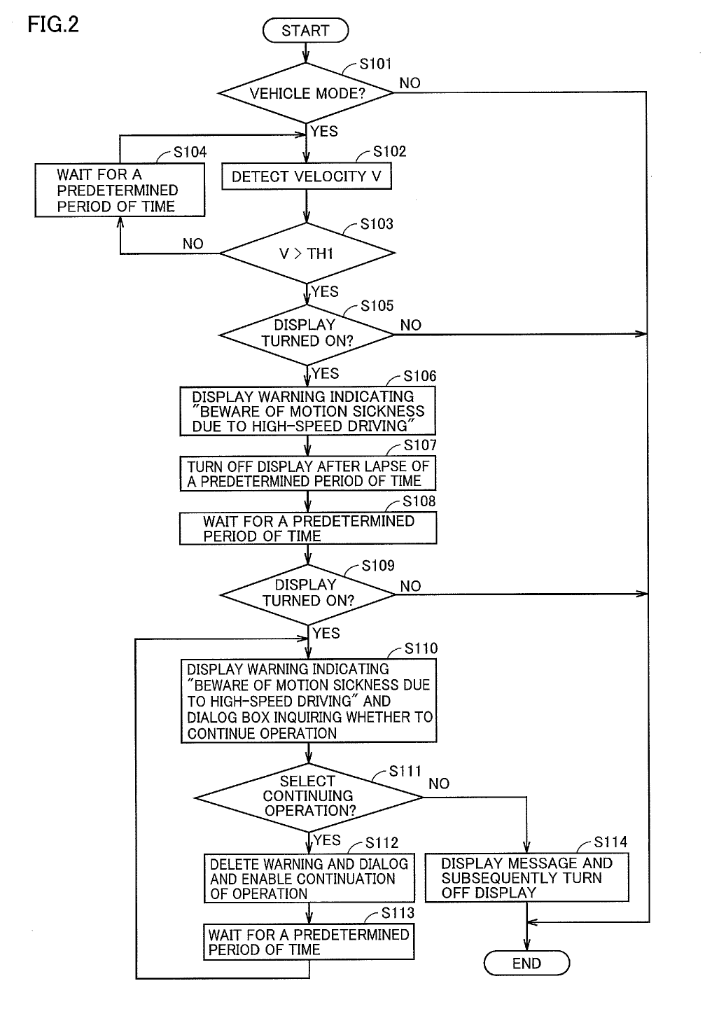

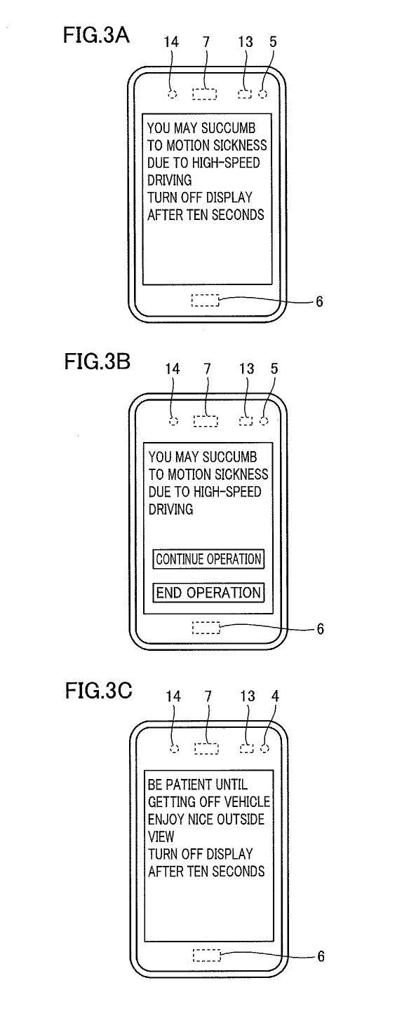

FIG. 2 is an illustration of a flowchart showing an example of an operation procedure of mobile terminal 1. FIGS. 3A, 3B, and 3C are illustrations of examples of screens displayed on mobile terminal 1.

With reference to FIG. 2 and FIGS. 3A to 3C, in step S101, controller 20 allows the process to proceed to step S102 if mobile terminal 1 has been set to a vehicle mode.

In step S102, controller 20 can detect a velocity V of mobile terminal 1 based on a signal output from acceleration sensor 17 or GPS receiver 18. Controller 20 can determine the velocity at which the current position indicated by the signal output from GPS receiver 18 changes to compute velocity V of mobile terminal 1. Alternatively, controller 20 may cause GPS receiver 18 to receive signals from a GPS satellite at predetermined time intervals to compute and integrate a phase shift from the signal. Controller 20 may analyze the integrated value in consideration of the Doppler effect to compute velocity V of mobile terminal 1. Alternatively, controller 20 may integrate an acceleration represented by the signal output from acceleration sensor 17 to compute velocity V of mobile terminal 1.

In step S103, controller 20 allows the process to proceed to step S105 if velocity V exceeds a predetermined velocity TH1 (e.g., 60 km per hour) or allows the process to proceed to step S104 if velocity V is not greater than predetermined velocity TH1.

In step S104, controller 20 allows the process to return to step S102 after waiting for a predetermined period of time.

In step S105, controller 20 allows the process to proceed to step S106 if display 8 of mobile terminal 1 is ON or can end the process if display 8 of mobile terminal 1 is OFF.

In step S106, controller 20 can display a warning indicating “Beware of motion sickness due to high-speed driving.” on display 8 as shown in FIG. 3A. Controller 20 may display the warning on display 8 and also emit a warning sound from speaker 7. Controller 20 may display the warning on display 8 and also cause vibrator 16 to vibrate.

In step S107, controller 20 can set display 8 to OFF after a lapse of a certain period of time (e.g., three seconds).

In step S108, controller 20 allows the process to proceed to step S109 after waiting for a predetermined period of time.

In step S109, controller 20 allows the process to proceed to step S110 if the user turns on display 8 by any operation or can end the process if display 8 is OFF.

In step S110, controller 20 displays a warning indicating “Beware of motion sickness due to high-speed driving. Continue the operation?” and dialog boxes inquiring whether to continue the operation on display 8 as shown in FIG. 3B.

In step S111, controller 20 allows the process to proceed to step S112 if the user selects continuing the operation within a predetermined period of time (e.g., three seconds) or allows the process to proceed to step S114 if the user selects ending the operation or performs no operation within the predetermined period of time.

In step S112, controller 20 deletes the warning and dialog display on display 8 to enable the continuation of the operation.

In step S113, controller 20 allows the process to proceed to step S110 after waiting for a predetermined period of time (e.g., ten minutes). Consequently, the warning indicating “Beware of motion sickness due to high-speed driving. Continue the operation?” is displayed on display 8.

In step S114, controller 20 displays a message indicating turning off display 8 on display 8 as shown in FIG. 3C. Subsequently, controller 20 sets display 8 to OFF.

As described above, mobile terminal 1 may detect the velocity of mobile terminal 1 to determine whether mobile terminal 1 has been brought into a vehicle traveling at high speed. When determining that it has been brought into a vehicle traveling at high speed, mobile terminal 1 instructs the user to end the operation of mobile terminal 1. This enables the user of mobile terminal 1 to be less susceptible to motion sickness.

### Variation of First Embodiment

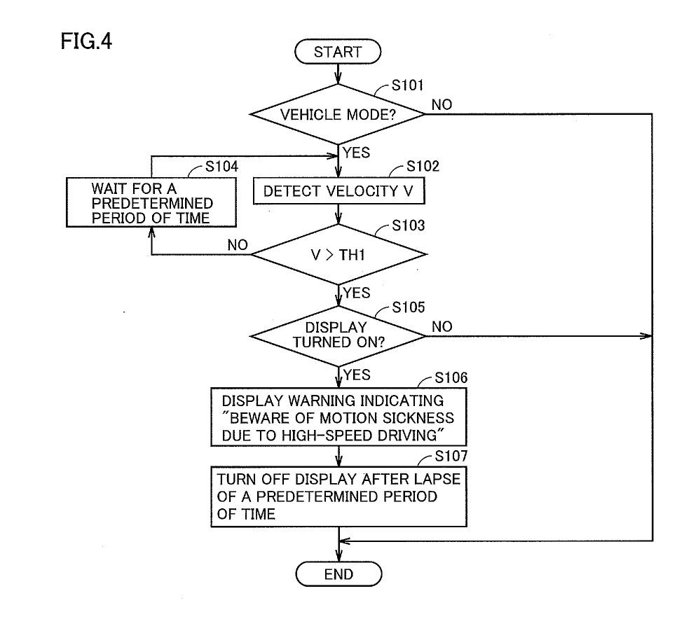

FIG. 4 is an illustration of a flowchart showing another example of the operation procedure of mobile terminal 1.

Since the process of steps S101 to S107 of FIG. 4 is similar to the process of steps S101 to S107 of FIG. 2, description thereof will not be repeated.

In this flowchart, controller 20 sets display 8 to OFF after a lapse of a predetermined period of time (e.g., three seconds) in step S107, and then ends the process.

Consequently, when mobile terminal 1 determines that it has been brought into a vehicle traveling at high speed, mobile terminal 1 can display a warning on display 8 and turn off display 8 after a lapse of a predetermined period of time, thereby ending warning display control.

In this flowchart, even if the user turns on display 8 by any operation (YES in step S109) after step S107, the process of step S110 and subsequent steps will not be performed.

### Second Embodiment

In one embodiment, mobile terminal 1 may determine a risk of motion sickness using an acceleration.

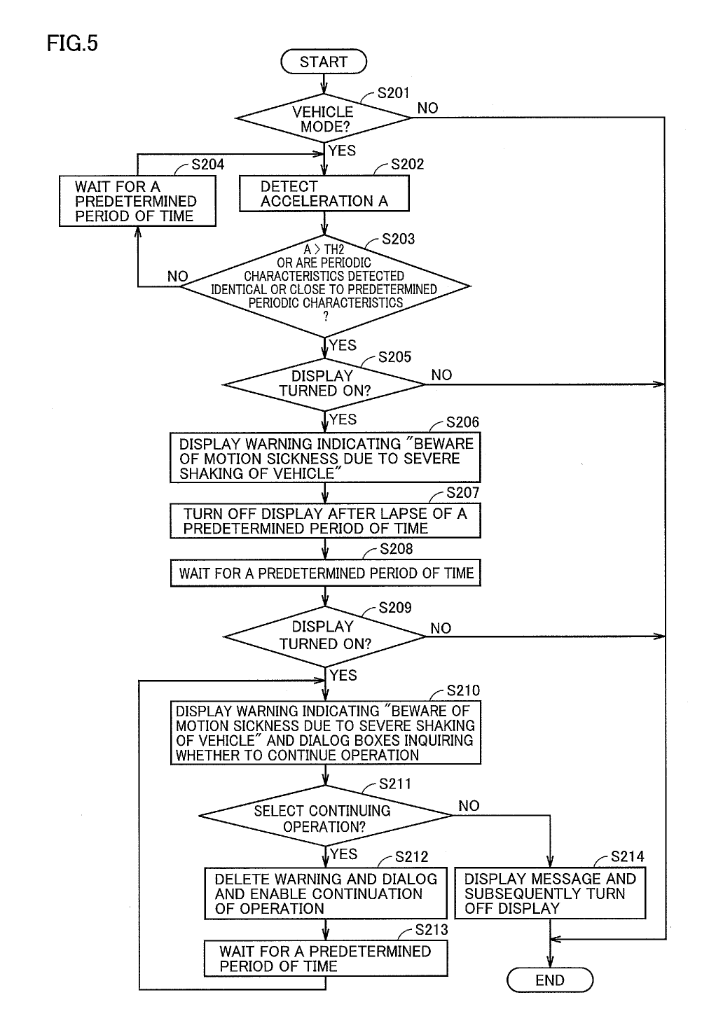

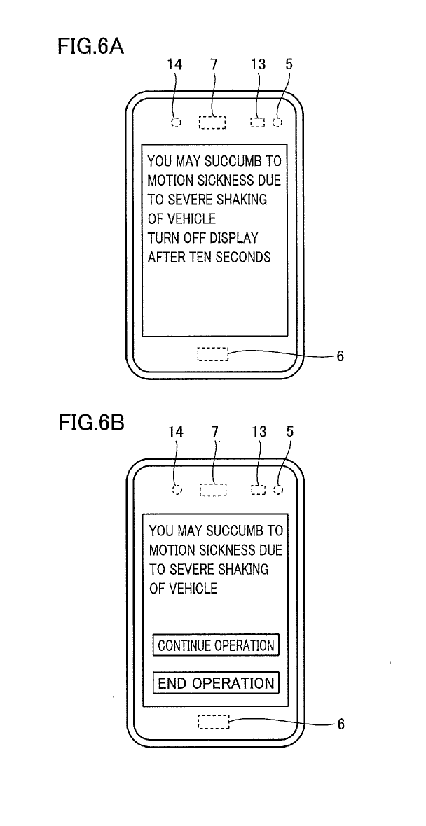

FIG. 5 is an illustration of a flowchart showing an example of the operation procedure of mobile terminal 1. FIGS. 6A and 6B are illustrations of other examples of the screens displayed on mobile terminal 1.

With reference to FIG. 5 and FIGS. 6A and 6B, in step S201, controller 20 allows the process to proceed to step S202 if mobile terminal 1 has been set to the vehicle mode.

In step S202, controller 20 can detect an acceleration A of mobile terminal 1 based on a signal output from acceleration sensor 17. Controller 20 may obtain accelerations A at predetermined time intervals over time and cause memory 35 to store these accelerations.

In step S203, controller 20 allows the process to proceed to step S205 if acceleration A exceeds a predetermined acceleration TH2 or allows the process to proceed to step S204 if acceleration A is not greater than predetermined acceleration TH2. Alternatively, controller 20 may detect periodic characteristics of acceleration A from accelerations A stored over time. Controller 20 may allow the process to proceed to step S205 if the periodic characteristics determined are identical or close to predetermined periodic characteristics. Controller 20 may allow the process to proceed to step S204 if the periodic characteristics determined are not identical or close to the predetermined periodic characteristics. The predetermined periodic characteristics may be preliminarily stored in memory 35. The predetermined periodic characteristics may be extracted from, for example, the accelerations obtained over time in a vehicle traveling on a road surface that is assumed to readily lead to motion sickness.

In step S204, controller 20 allows the process to return to step S202 after waiting for a predetermined period of time.

In step S205, controller 20 allows the process to proceed to step S206 if display 8 of mobile terminal 1 is ON or can end the process if display 8 of mobile terminal 1 is OFF.

In step S206, controller 20 can display a warning indicating “Beware of motion sickness due to severe shaking of the vehicle” on display 8 as shown in FIG. 6A. Controller 20 may display the warning on display 8 and also emit a warning sound from speaker 7. Controller 20 may display the warning on display 8 and also cause vibrator 16 to vibrate.

In step S207, controller 20 can set display 8 to OFF after a lapse of a predetermined period of time (e.g., three seconds).

In step S208, controller 20 allows the process to proceed to step S209 after waiting for a predetermined period of time.

In step S209, controller 20 allows the process to proceed to step S210 if the user turns on display 8 by any operation or can end the process if display 8 is OFF.

In step S210, controller 20 displays a warning indicating “Beware of motion sickness due to severe shaking of the vehicle. Continue the operation?” and dialog boxes inquiring whether to continue the operation on display 8 as shown in FIG. 6B.

In step S211, controller 20 allows the process to proceed to step S212 if the user selects continuing the operation within a predetermined period of time (e.g., three seconds) or allows the process to proceed to step S214 if the user selects ending the operation or performs no operation within the predetermined period of time.

In step S212, controller 20 deletes the warning and dialog display on display 8 and enables the continuation of the operation.

In step S213, controller 20 allows the process to proceed to step S210 after waiting for a predetermined period of time (e.g., ten minutes). Consequently, a warning indicating “Beware of motion sickness. Continue the operation?” is displayed again on display 8.

In step S214, controller 20 displays a message indicating turning off display 8 on display 8 as shown in FIG. 3C. Controller 20 subsequently sets display 8 to OFF.

As described above, mobile terminal 1 may detect an acceleration of mobile terminal 1 to determine whether mobile terminal 1 has been brought into a vehicle shaking severely. Mobile terminal 1 instructs the user to end the operation of mobile terminal 1 if determining that it has been brought into a vehicle shaking severely. Non-limiting examples of the shaking include pitching and rolling.

### Variation of Second Embodiment

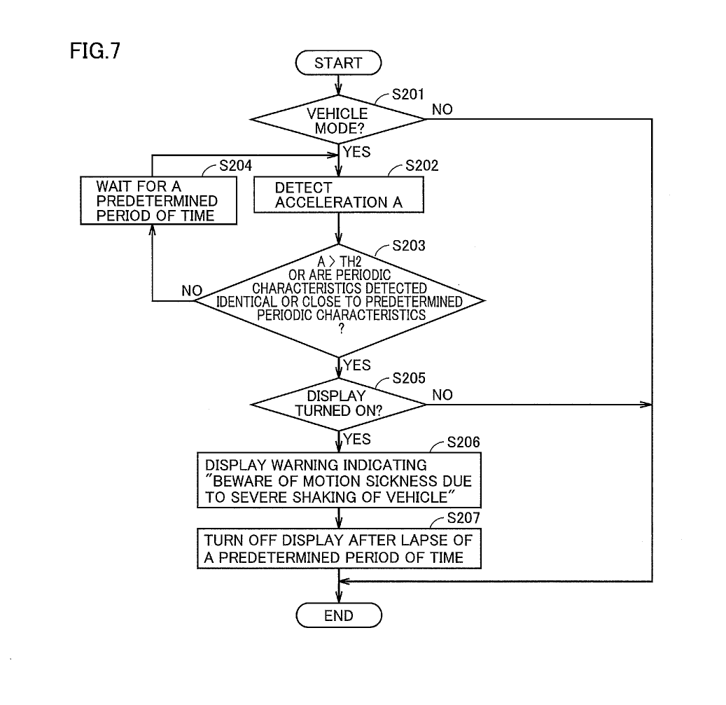

FIG. 7 is an illustration of a flowchart showing another example of the operation procedure of mobile terminal 1.

Since the process of steps S201 to S207 of FIG. 7 is similar to the process of steps S201 to S207 of FIG. 5, description thereof will not be repeated.

In this flowchart, controller 20 sets display 8 to OFF after a lapse of a predetermined period of time (e.g., three seconds) in step S207, and subsequently ends the process.

Consequently, if determining that is has been brought into a vehicle shaking severely, mobile terminal 1 can display a warning on display 8 and turn off display 8 after a predetermined period of time, thereby ending warning display control.

In this flowchart, the process of step S210 and subsequent steps will not be performed even if the user turns on display 8 by any operation (YES in step S209) after step S207.

### Third Embodiment

In one embodiment, mobile terminal 1 may determine a risk of motion sickness based on the characteristics of a road on which the vehicle is traveling.

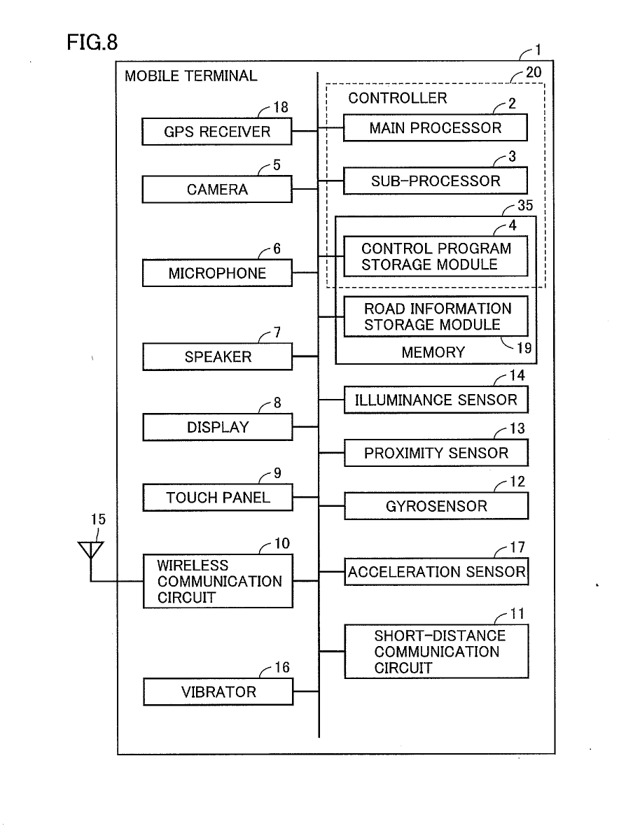

FIG. 8 is another illustration of the configuration of mobile terminal 1.

Mobile terminal 1 of FIG. 8 differs from mobile terminal 1 of FIG. 1 in the following respect.

Memory 35 includes a road information storage module 19 that stores road information. The road information is information representing road characteristics. Non-limiting examples of the road information include information about curves of roads and information about undulations of roads. Examples of the information about curves of roads include the information about from where to where a curve with an angle not smaller than a predetermined angle continues.

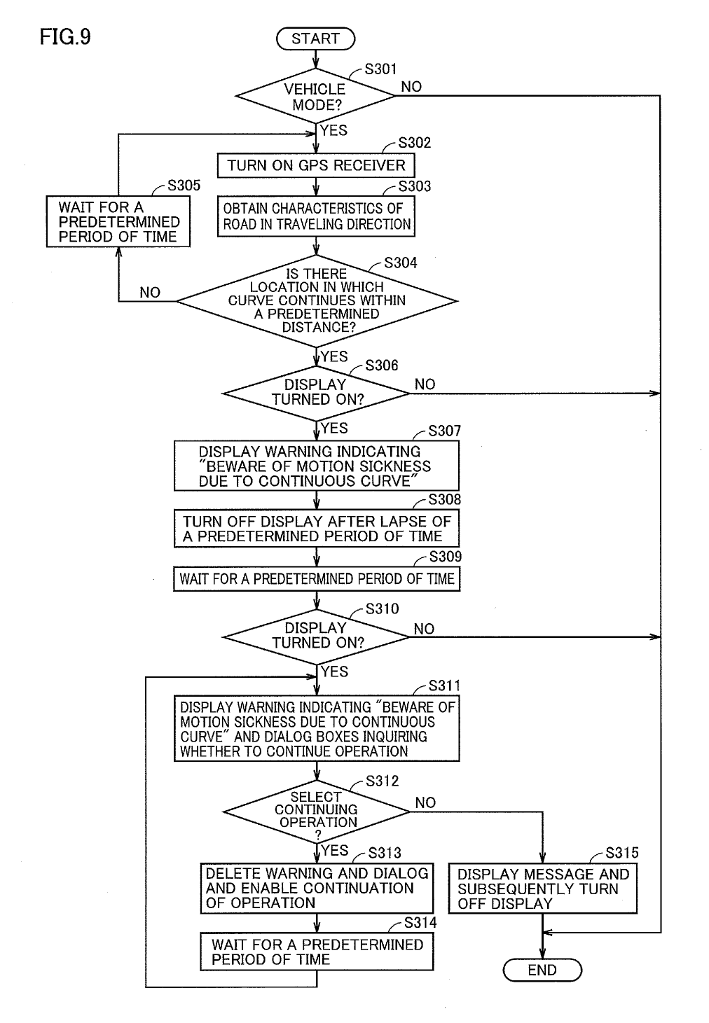

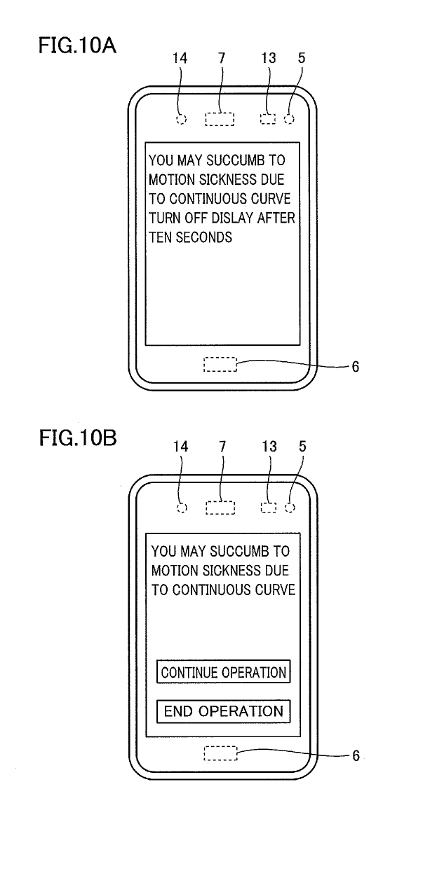

FIG. 9 is an illustration of a flowchart showing another example of the operation procedure of mobile terminal 1. FIGS. 10A and 10B show other examples of the screens displayed on mobile terminal 1.

With reference to FIG. 9 and FIGS. 10A and 10B, in step S301, controller 20 allows the process to proceed to step S302 if mobile terminal 1 has been set to the vehicle mode.

In step S302, controller 20 can turn on GPS receiver 18.

In step S303, controller 20 refers to the road information in the road information storage module to obtain the characteristics of a road on which the vehicle is traveling.

In step S304, controller 20 allows the process to proceed to step S306 if there is a location in which a curve with an angle not smaller than a predetermined angle (e.g., 30 degrees) continues for not smaller than a predetermined length (e.g., 200 m) within a range from a current position to a position to which the vehicle will travel for a predetermined distance. If there is no such a location, controller 20 allows the process to proceed to step S305.

In step S305, controller 20 allows the process to return to step S302 after waiting for a predetermined period of time.

In step S306, controller 20 allows the process to proceed to step S307 if display 8 of mobile terminal 1 is ON or can end the process if display 8 of mobile terminal 1 is OFF.

In step S307, controller 20 can display a warning indicating “Beware of motion sickness due to a continuous curve” on display 8 as shown in FIG. 10A,

In step S308, controller 20 can set display 8 to OFF after a lapse of a predetermined period of time (e.g., three seconds). Controller 20 may display the warning on display 8 and also emit a warning sound from speaker 7. Controller 20 may display the warning on display 8 and also cause vibrator 16 to vibrate.

In step S309, controller 20 allows the process to proceed to step S310 after waiting for a predetermined period of time.

In step S310, controller 20 allows the process to proceed to step S311 if the user turns on display 8 by any operation or can end the process if display 8 is OFF.

In step S311, controller 20 displays a warning indicating “Beware of motion sickness due to a continuous curve. Continue the operation?” and dialog boxes inquiring whether to continue the operation on display 8 as shown in FIG. 10B.

In step S312, controller 20 allows the process to proceed to step S313 if the user selects continuing the operation within a predetermined period of time (e.g., three seconds) or allows the process to proceed to step S315 if the user selects ending the operation or performs no operation within the predetermined period of time.

In step S313, controller 20 deletes the warning and dialog display on display 8 and enables the continuation of the operation.

In step S314, controller 20 allows the process to proceed to step S311 after waiting for a predetermined period of time (e.g., ten minutes). Consequently, the warning indicating “Beware of motion sickness. Continue the operation?” on display 8.

In step S315, controller 20 displays a message indicating turning off display 8 on display 8 as shown in FIG. 3C. Subsequently, controller 20 sets display 8 to OFF.

As described above, mobile terminal 1 may detect the characteristics of a road on which the vehicle is traveling to determine whether the vehicle into which mobile terminal 1 has been brought will pass through a location that readily leads to motion sickness in the near future. Mobile terminal 1 instructs the user to end the operation of mobile terminal 1 when the vehicle into which mobile terminal 1 has been brought will pass through a location that readily leads to motion sickness in the near feature by detecting the characteristics of the road on which the vehicle is traveling.

### Variation of Third Embodiment

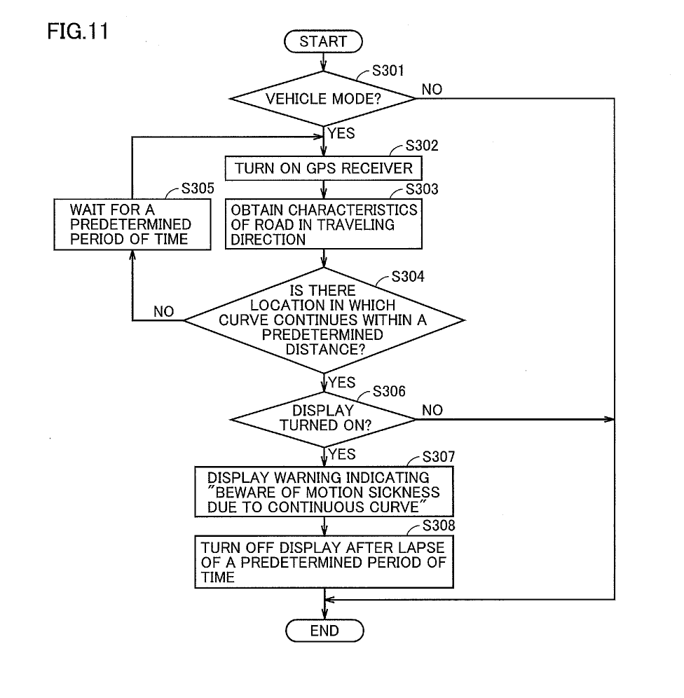

FIG. 11 is an illustration of a flowchart showing another example of the operation procedure of mobile terminal 1.

Since the process of steps S301 to S308 of FIG. 11 is similar to the process of steps S301 to S308 of FIG. 9, description thereof will not be repeated.

In this flowchart, in step S308, controller 20 sets display 8 to OFF after a lapse of a predetermined period of time (e.g., three seconds) and then ends the process.

Consequently, mobile terminal 1 can display a warning on display 8 if determining that the vehicle into which it has been brought will pass through a location that readily leads to motion sickness in the near feature and turn off display 8 after a lapse of a predetermined period of time, thereby ending warning display control.

In this flowchart, the process of step S311 and subsequent steps will not be performed even if the user turns on display 8 by any operation (YES in step S310) after step S308.

### Fourth Embodiment

In one embodiment, mobile terminal 1 can notify the user of a risk of motion sickness in response to a signal notified by the vehicle. In one embodiment, the vehicle may determine a risk of motion sickness based on a velocity.

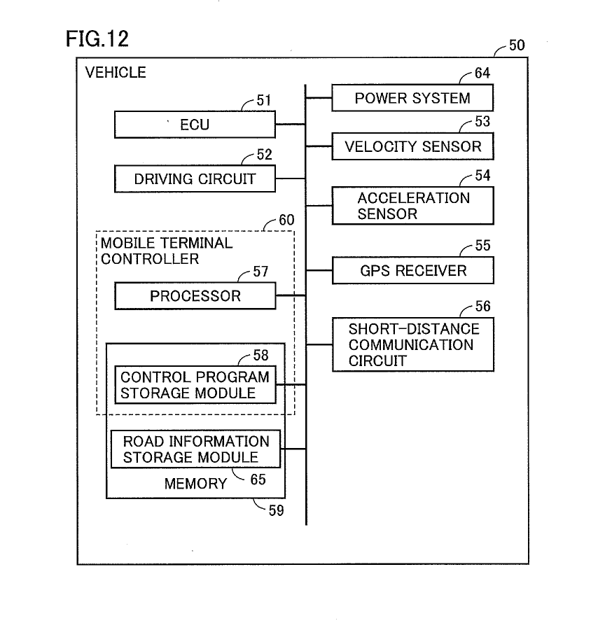

FIG. 12 is an illustration of a configuration of a vehicle according to an embodiment.

A vehicle 50 includes an engine control unit (ECU) 51, a driving circuit 52, a velocity sensor 53, an acceleration sensor 54, a GPS receiver 55, a short-distance communication circuit 56, a processor 57, a memory 59, and a power system 64.

ECU 51 can control an engine.

Power system 64 can include an engine and a motor.

Driving circuit 52 can drive the motor.

Velocity sensor 53 can detect the velocity of the vehicle based on the rpm of an axel shaft.

Memory 59 can store various types of data and programs. Memory 59 includes a control program storage module 58 that stores a control program and a road information storage module 65 that stores road information.

Since the road information is similar to that described in the third embodiment, description thereof will not be repeated.

Processor 57 executes a control program to function as a mobile terminal controller 60. Mobile terminal controller 60 can control mobile terminal 1 by transmitting a notification signal to mobile terminal 1 via short-distance communication circuit 56.

Short-distance communication circuit 56 can establish short-distance wireless communication with mobile terminal 1 in accordance with the Bluetooth® system when mobile terminal 1 is brought into vehicle 50. The Bluetooth® system is one example of the short-distance wireless communication systems, and short-distance communication circuit 56 may follow another short-distance wireless communication system. Non-limiting examples of the other short-distance wireless communication systems include a digital enhanced cordless telecommunications (DECT) system, a dedicated short range distance communications (DSRC) system, an IBeacon system, an IrDA system, a near field communication (NFC) system, a TransferJet system, a WiMedia Alliance system, a ZigBee system, a Z-wave system, and a Wi-Fi system.

Acceleration sensor 54 can detect accelerations. Vehicle 50 may obtain accelerations detected by acceleration sensor 54 at predetermined time intervals over time and detect the periodic characteristics of the obtained accelerations by analysis. Acceleration sensor 54 includes, for example, a triaxial acceleration sensor. In order to detect the periodic characteristics of accelerations, vehicle 50 may subject the acceleration of each axis or a predetermined axis to Fast Fourier Transform (FFT) to obtain a power spectrum, thereby analyzing periodic characteristics.

GPS receiver 55 can detect a current position. When mobile terminal 1 is brought into vehicle 50, the position of vehicle 50 can be regarded as the position of mobile terminal 1, the velocity of vehicle 50 can be regarded as the velocity of mobile terminal 1, and the acceleration of vehicle 50 can be regarded as the acceleration of mobile terminal 1. GPS receiver 55 is one example of the positional information receiver. The positional information receiver can be a receiver capable of receiving navigation signals transmitted from navigation satellites. Non-limiting examples of the positional information receiver include a GLObal'naya NAvigatsionnaya Sputnikovaya Sistema (GLONASS) receiver, a Galileo receiver, a Compass receiver, an Indian regional navigational satellite (IRNSS) receiver, and a quasi-zenith satellite system (QZSS) receiver. Vehicle 50 may include multiple positional information receivers and specify its position based on the navigation signal obtained by each of the multiple positional information receivers.

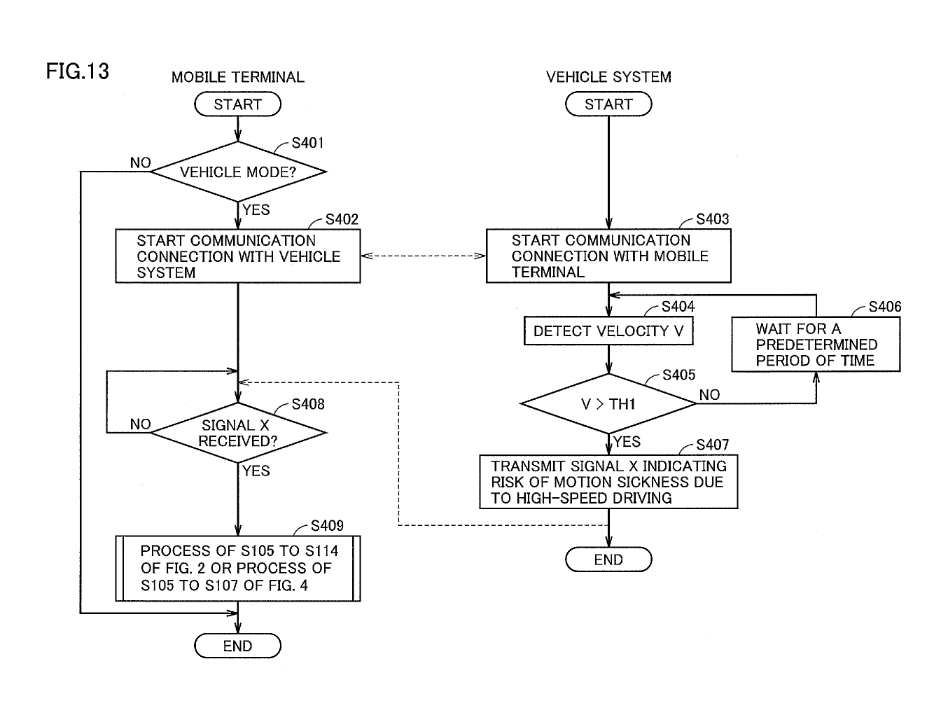

FIG. 13 is an illustration of a flowchart showing another example of the operation procedure of mobile terminal 1.

In step S401, mobile terminal controller 60 allows the process to proceed to step S402 if mobile terminal 1 has been set to the vehicle mode.

In steps S402 and S403, short-distance communication circuit 11 of mobile terminal 1 and short-distance communication circuit 56 of vehicle 50 establish communication connection by the Bluetooth® system.

In step S404, mobile terminal controller 60 of vehicle 50 can detect a velocity V of vehicle 50 based on a signal output from velocity sensor 53.

In step S405, mobile terminal controller 60 of vehicle 50 allows the process to proceed to step S407 if velocity V exceeds a predetermined velocity TH1 (e.g., 60 km per hour) or allows the process to proceed to step S406 if velocity V is not greater than predetermined velocity TH1.

In step S406, mobile terminal controller 60 of vehicle 50 allows the process to return to step S404 after waiting for a predetermined period of time.

In step S407, mobile terminal controller 60 of vehicle 50 can transmit a signal X indicating a risk of motion sickness due to high-speed driving to mobile terminal 1 via short-distance communication circuit 56.

In step S408, controller 20 of mobile terminal 1 allows the process to proceed to step S409 if receiving signal X via short-distance communication circuit 11.

In step S409, the process of steps S105 to S114 of the flowchart of FIG. 2 or the process of steps S105 to S107 of the flowchart of FIG. 4 can be performed as in the first embodiment or the variation thereof.

As described above, vehicle 50 notifies mobile terminal 1 brought into vehicle 50 of a risk of motion sickness if the speed of vehicle 50 is high. Upon receipt of this notification, mobile terminal 1 instructs the user to end the operation of mobile terminal 1.

### Fifth Embodiment

In one embodiment, mobile terminal 1 can notify the user of a risk of motion sickness in response to a signal notified by the vehicle. The vehicle may determine a risk of motion sickness based on acceleration.

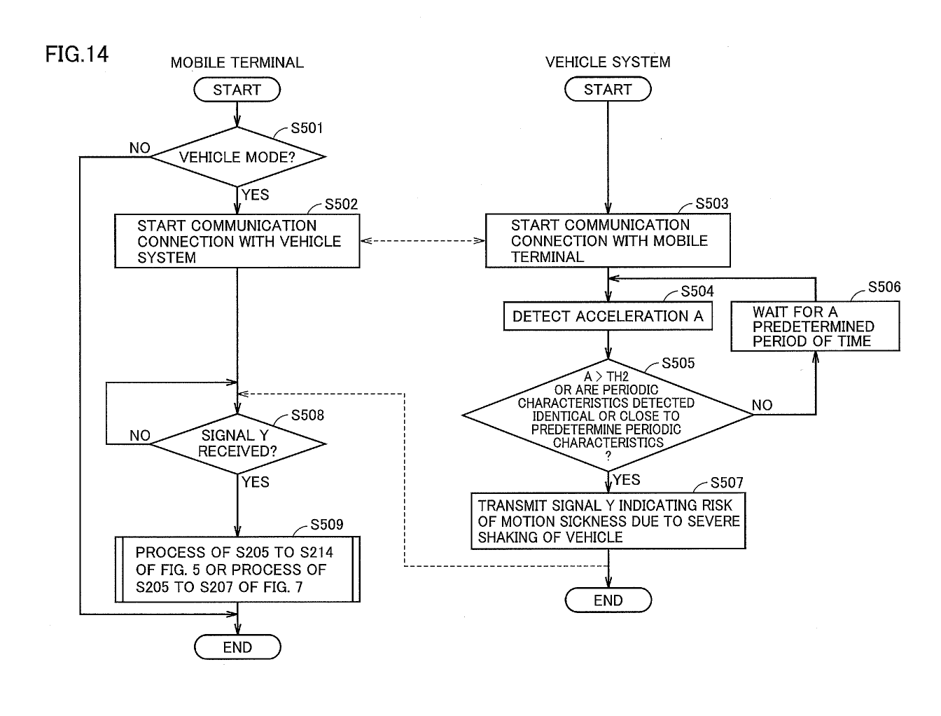

FIG. 14 is an illustration of a flowchart showing another example of the operation procedure of mobile terminal 1 according to one embodiment.

In step S501, controller 20 allows the process to proceed to step S502 if mobile terminal 1 has been set to the vehicle mode.

In steps S502 and S503, short-distance communication circuit 11 of mobile terminal 1 and short-distance communication circuit 56 of vehicle 50 establish communication connection by the Bluetooth® system.

In step S504, mobile terminal controller 60 of vehicle 50 can detect an acceleration A of vehicle 50 based on a signal output from acceleration sensor 54. Mobile terminal controller 60 may obtain accelerations A at predetermined time intervals over time based on the signal output from acceleration sensor 54 and store the obtained accelerations A in memory 59.

In step S505, mobile terminal controller 60 of vehicle 50 allows the process to proceed to step S507 if acceleration A exceeds a predetermined acceleration TH2 or allows the process to proceed to step S506 if acceleration A is not greater than predetermined acceleration TH2. Alternatively, mobile terminal controller 60 may detect the periodic characteristics of acceleration A from accelerations A stored over time. Mobile terminal controller 60 may allow the process to proceed to step S507 if the periodic characteristics detected are identical or close to predetermined periodic characteristics. Mobile terminal controller 60 may allow the process to proceed to step S506 if the periodic characteristics detected are not identical or close to the predetermined periodic characteristics. The predetermined periodic characteristics may be preliminarily stored in memory 59. The predetermined periodic characteristics may be extracted from the accelerations preliminarily obtained from, for example, the acceleration sensor of the vehicle traveling on the road surface that is assumed to readily lead to motion sickness.

In step S506, mobile terminal controller 60 of vehicle 50 allows the process to return to step S504 after waiting for a predetermined period of time.

In step S507, mobile terminal controller 60 of vehicle 50 can transmit a signal Y indicating a risk of motion sickness due to severe shaking of the vehicle to mobile terminal 1 via short-distance communication circuit 56. In step S508, controller 20 of mobile terminal 1 allows the process to proceed to step S509 if receiving signal Y via short-distance communication circuit 11.

In step S509, the process of steps S205 to S214 of the flowchart of FIG. 5 or the process of steps S205 to S207 of the flowchart of FIG. 7 is performed as in the second embodiment or the variation thereof.

As described above, in the fifth embodiment, vehicle 50 notifies mobile terminal 1 brought into vehicle 50 of a risk of motion sickness if the acceleration of vehicle 50 is high. Upon receipt of this notification, mobile terminal 1 instructs the user to end the operation of mobile terminal 1. This enables the user to be less susceptible to motion sickness.

### Sixth Embodiment

In one embodiment, mobile terminal 1 can notify the user of a risk of motion sickness in response to a signal notified by the vehicle. The vehicle may determine a risk of motion sickness based on road characteristics.

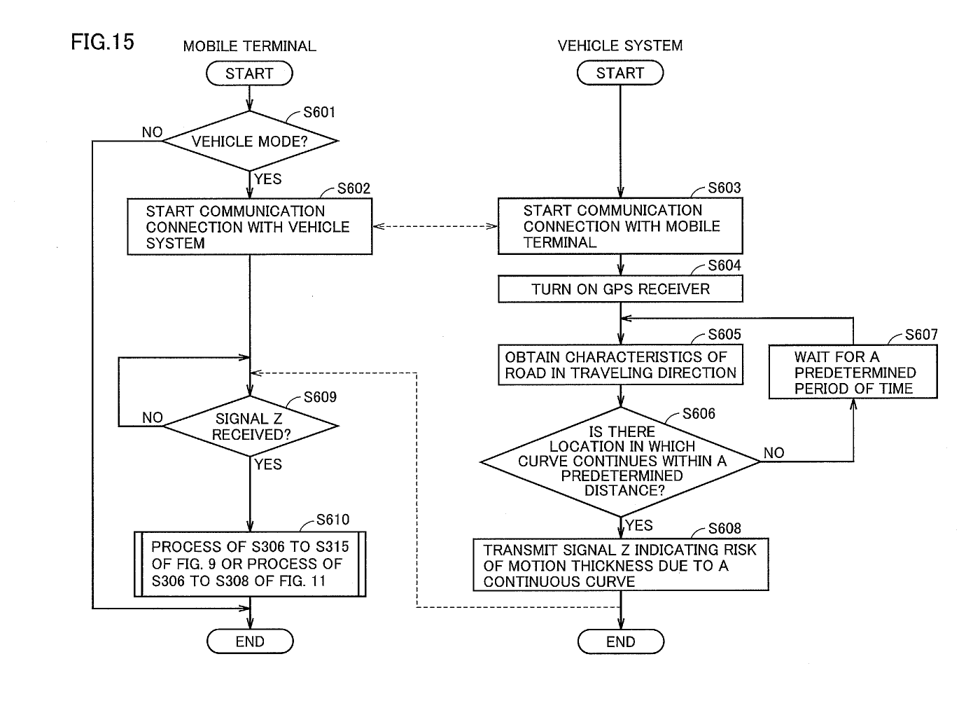

FIG. 15 is an illustration of a flowchart showing another example of the operation procedure of mobile terminal 1 according to one embodiment.

In step S601, controller 20 allows the process to proceed to step S602 if mobile terminal 1 has been set to the vehicle mode.

In steps S602 and S603, short-distance communication circuit 11 of mobile terminal 1 and short-distance communication circuit 56 of vehicle 50 establish communication connection by the Bluetooth® system.

In step S604, mobile terminal controller 60 of vehicle 50 can turn on GPS receiver 55.

In step S605, mobile terminal controller 60 of vehicle 50 refers to road information to obtain the characteristics of the road in the traveling direction of vehicle 50.

In step S606, mobile terminal controller 60 of vehicle 50 allows the process to proceed to step S608 if there is a location in which an angle not smaller than a predetermined angle (e.g., 30 degrees) continues for not smaller than a predetermined length (e.g., 200 m) within a range from a current position to a position to which the vehicle will travel for a predetermined distance. If there is no such a location, the controller allows the process to proceed to step S607.

In step S607, mobile terminal controller 60 of vehicle 50 allows the process to return to step S605 after waiting for a predetermined period of time.

In step S608, mobile terminal controller 60 of vehicle 50 can transmit a signal Z indicating a risk of motion sickness due to a continuous curve to mobile terminal 1 via short-distance communication circuit 56.

In step S609, controller 20 of mobile terminal 1 allows the process to proceed to step S610 if receiving signal Z via short-distance communication circuit 11.

In step S610, the process of steps S306 to S315 of the flowchart of FIG. 9 or the process of steps S306 to S308 of the flowchart of FIG. 11 is performed as described above.

As described above, vehicle 50 may notify mobile terminal 1 brought into vehicle 50 of a risk of motion sickness if a sharp curve continues on the road on which the vehicle is traveling. Upon receipt of this notification, mobile terminal 1 instructs the user to end the operation of mobile terminal 1

### Seventh Embodiment

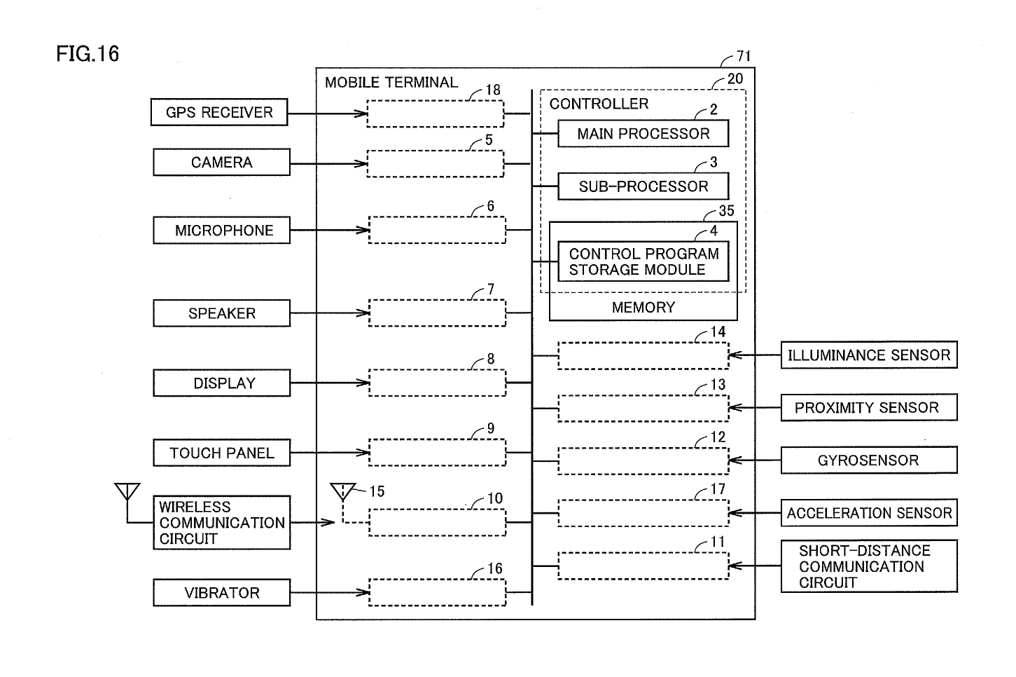

FIG. 16 is another illustration of a configuration of a mobile terminal according to one embodiment.

A mobile terminal 71 includes main processor 2, sub-processor 3, and memory 35. Mobile terminal 71 is configured such that other components can be mounted thereto. Camera 5, microphone 6, speaker 7, display 8, touch panel 9, wireless communication circuit 10, short-distance communication circuit 11, gyrosensor 12, acceleration sensor 17, proximity sensor 13, illuminance sensor 14, antenna 15, and GPS receiver 18 can be mounted to mobile terminal 71. These components have functions similar to those described in the above embodiments. Mobile terminal 71, to which some or all of these components are mounted, can achieve effects similar to those described in the above embodiments.

### Variations

Variations below are included in the scope of the present disclosure.

### (1) Road Information

Although a risk of motion sickness is determined if there is a location in which an angle not smaller than a predetermined angle (e.g., 30 degrees) continues for not smaller than a predetermined length (e.g., 200 m) within a range from a current position to a position to which the vehicle will travel for a predetermined distance in the third to sixth embodiments, the present disclosure is not limited to this.

A risk of motion sickness may be determined if the vehicle is approaching a curve having a short length but having an extremely large angle. Alternatively, a risk of motion sickness may be determined if the vehicle experiences a predetermined number of undulations of not smaller than a predetermined angle within a predetermined period.

(2) Transmission of Signals from Vehicle to Mobile Terminal

Although signal X indicating a risk of motion sickness due to high-speed driving and signal Y indicating a risk of motion sickness due to severe shaking of a vehicle are transmitted in the fourth and fifth embodiments, the present disclosure is not limited to this. For example, the vehicle may transmit a signal indicating velocity or acceleration for each predetermined period of time, and the mobile terminal may determine whether the received velocity or acceleration exceeds a predetermined value.

### (3) Vehicle Mode

The process of preventing motion sickness described in the above embodiments may be performed regardless of the presence or absence of the setting of a vehicle mode. Specifically, step S101 of FIGS. 2 and 4, step S201 of FIGS. 5 and 7, step S301 of FIGS. 9 and 11, step S401 of FIG. 13, step S501 of FIG. 14, and step S601 of FIG. 15 may be omitted.

Mobile terminal 1 may set the vehicle mode in accordance with, for example, an instruction from an instruction input device such as touch panel 9. Mobile terminal 1 may set the vehicle mode when, for example, determining that the periodic characteristics detected are identical or close to the periodic characteristics of the acceleration generated in a traveling vehicle based on the acceleration detected by acceleration sensor 17. Upon receipt of a specific signal issued from a vehicle or an in-car device mounted on the vehicle from short-distance communication circuit 11, mobile terminal 1 may set the vehicle mode.

### (4) Use of Information Detected by Sensor Attached to Tire

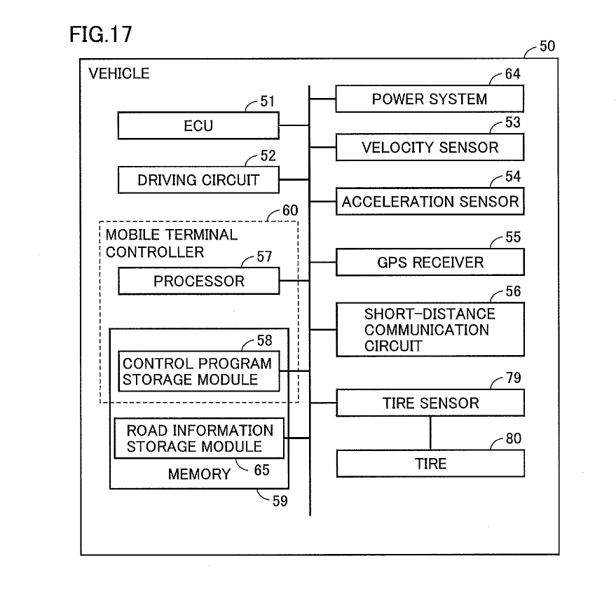

FIG. 17 is an illustration of another example of the configuration of the vehicle.

As shown in FIG. 17, vehicle 50 includes a tire 80 to which a tire sensor 79 is attached. Tire sensor 79 is any one of sensors including an acceleration sensor, a distortion sensor, a temperature sensor, a gyrosensor, a humidity sensor, and a pressure sensor, or any combination of some of these sensors.

Mobile terminal controller 60 may obtain information detected by tire sensor 79. Mobile terminal controller 60 may estimate the condition of a road surface on which the vehicle is traveling or the behavior of vehicle 50 based on the obtained information detected by tire sensor 79. Mobile terminal controller 60 may estimate the condition of a road surface that may lead to motion sickness as a to-be-estimated condition of a road surface on which the vehicle is traveling. Mobile terminal controller 60 may estimate the condition of a road surface with a risk of motion sickness as the condition of a road surface on which the vehicle is traveling. Mobile terminal controller 60 may estimate the behavior with a risk of motion sickness as the behavior of vehicle 50.

Mobile terminal controller 60 may estimate the condition of a road surface with a risk of motion sickness or the behavior with a risk of motion sickness if detecting predetermined characteristics, based on the information detected by tire sensor 79. The predetermined characteristics may be extracted by preliminarily causing an experimental vehicle to travel on a road surface with a risk of motion sickness or causing the experimental vehicle to perform a behavior with a risk of motion sickness, and then obtaining and analyzing the information from tire sensor 79. The extracted characteristics may be preliminarily stored in memory 59, and mobile terminal controller 60 may compare the result obtained by analyzing the information detected by tire sensor 79 with the extracted characteristics to determine that predetermined characteristics have been detected. In estimation of the condition of a road surface on which the vehicle is traveling or the behavior of vehicle 50, mobile terminal controller 60 may supplementarily use the information from any sensor other than tire sensor 79 or the information obtained from a drive assist system such as the intelligent transport system (ITS) for higher accuracy of estimation results.

Upon detection of the condition of a road surface with a risk of motion sickness or the behavior with a risk of motion sickness, mobile terminal controller 60 may transmit a signal indicating a risk of motion sickness to mobile terminal 1 via short-distance communication circuit 56. For example, vehicle 50 includes an acceleration sensor serving as tire sensor 79, and mobile terminal controller 60 may transmit a signal indicating a risk of motion sickness to mobile terminal 1 via short-distance communication circuit 56 when the information obtained from tire sensor 79 is identical or close to the periodic characteristics of a predetermined acceleration preliminarily stored in memory 59.

### (5) Use of Other Information

A risk of motion sickness may be determined based on, for example, the temperature in a vehicle, whether a vehicle is ventilated, or information about road traffic congestion. A risk of motion sickness may be determined based on the information about the condition of the road surface of a road which has been obtained from a drive assist system such as the intelligent transport system (ITS). The information about the condition of the road surface of a road includes the information obtained from road-to-vehicle communication or the information obtained from intervehicular communication.

### (6) Vehicle

The vehicles described in the above embodiments are not limited to automobiles and include, for example, buses, trains, airplanes, and ships.

### (7) Velocity, Acceleration

Velocities and accelerations by which a risk of motion sickness is determined are not limited to momentary ones. For example, a risk of motion sickness may be determined based on the velocity history and the acceleration history within a predetermined period of time.

Embodiments disclosed herein are illustrative and non-restrictive in every respect. The scope of the present disclosure is defined by the terms of the claims and is intended to include any variations within the scope and meaning equivalent to the terms of the claims.

1. A mobile terminal comprising:
a display; and
at least one processor configured to cause the display to display a message indicating a risk of motion sickness when a velocity of the mobile terminal satisfies a predetermined criterion.

2. The mobile terminal according to claim 1, wherein the at least one processor is configured to cause the display to display the message when the velocity of the mobile terminal has exceeded a predetermined value.

3. The mobile terminal according to claim 2, comprising a positional information receiver,
wherein the at least one processor is configured to determine whether the velocity of the mobile terminal has exceeded the predetermined value based on a signal output from the positional information receiver.

4. The mobile terminal according to claim 2, comprising a short-distance communication circuit configured to establish short-distance wireless communication with a vehicle, wherein
the short-distance communication circuit is configured to receive a predetermined signal from the vehicle when a velocity of the vehicle exceeds the predetermined value, and
the at least one processor is configured to cause the display to display the message when receiving the predetermined signal.

5. A mobile terminal comprising:
a display; and
at least one processor configured to cause the display to display a message indicating a risk of motion sickness when an acceleration of the mobile terminal satisfies a predetermined criterion.

6. The mobile terminal according to claim 5, wherein the at least one processor is configured to cause the display to display the message when the acceleration of the mobile terminal has exceeded a predetermined value.

7. The mobile terminal according to claim 6, comprising an acceleration sensor,
wherein the at least one processor is configured to determine whether magnitude of the acceleration of the mobile terminal has exceeded the predetermined value based on a signal output from the acceleration sensor.

8. The mobile terminal according to claim 6, comprising a short-distance communication circuit configured to establish short-distance wireless communication with a vehicle, wherein
the short-distance communication circuit is configured to receive a predetermined signal from the vehicle when an acceleration of the vehicle exceeds the predetermined value, and
the at least one processor is configured to cause the display to display the message when receiving the predetermined signal.

9. A mobile terminal comprising:
a display; and
at least one processor configured to cause the display to display a message indicating a risk of motion sickness when characteristics of a road on which the mobile terminal is traveling satisfy a predetermined criterion.

10. The mobile terminal according to claim 9, comprising:
a positional information receiver; and
a memory configured to store road information representing road characteristics,
wherein the at least one processor is configured to obtain the characteristics of the road on which the mobile terminal is traveling based on a signal output from the positional information receiver and the road information.

11. The mobile terminal according to claim 9, comprising a short-distance communication circuit configured to establish short-distance wireless communication with a vehicle, wherein
the short-distance communication circuit is configured to receive a predetermined signal from the vehicle when the characteristics of the road on which the vehicle is traveling satisfy the predetermined criterion, and
the at least one processor is configured to cause the display to display the message when receiving the predetermined signal.

12. The mobile terminal according to claim 9, wherein the predetermined criterion includes a criterion regarding a curve of a road.

13. The mobile terminal according to claim 12, wherein the at least one processor is configured to cause the display to display the message and subsequently turn off the displaying of the display.

14. The mobile terminal according to claim 12, comprising an input module for accepting an operation performed by a user,
wherein the at least one processor is configured to cause the display to display the message and a dialog for the user to select continuing or ending the operation via the input module.

15. The mobile terminal according to claim 14, wherein the at least one processor is configured to turn off the displaying of the display when the user selects ending the operation via the input module.

16. The mobile terminal according to claim 14, comprising an input module for accepting an operation performed by the user,
wherein the at least one processor is configured to keep turning on the displaying of the display and display the dialog again after a lapse of a predetermined period of time when the user selects continuing the operation via the input module.

17. The mobile terminal according to claim 12, wherein
the at least one processor is configured to set the mobile terminal to a vehicle mode, and
the at least one processor is configured to cause the display not to display the message on the display when the mobile terminal has not been set to the vehicle mode.

18. A vehicle comprising:
a short-distance communication circuit configured to establish short-distance wireless communication with a mobile terminal; and
at least one processor configured to transmit a predetermined signal via the short-distance communication circuit when a velocity of the vehicle exceeds a predetermined value or an acceleration of the vehicle exceeds a predetermined value.

19. A vehicle comprising:
a short-distance communication circuit configured to establish short-distance wireless communication with a mobile terminal;
a positional information receiver;
a memory configured to store road information; and
at least one processor configured to obtain characteristics of a road on which the vehicle is traveling based on a signal output from the positional information receiver and the road information and, when the characteristics satisfy a predetermined criterion, transmit a predetermined signal via the short-distance communication circuit.

20. A vehicle comprising:
a short-distance communication circuit configured to establish short-distance wireless communication with a mobile terminal;
a sensor attached to a tire; and
at least one processor configured to transmit a predetermined signal to the mobile terminal via the short-distance communication circuit when detecting predetermined characteristics based on a signal output from the sensor attached to the tire.
